(19) United States
(12) Patent Application Publication
(10) Pub. No.: US 2016/0292801 A1
(43) Pub. Date: Oct. 6, 2016

(54) System and Method for Creating, Managing, and Searching Real Estate Listings

(71) Applicant: Unrapp LLC

(72) Inventor: Nicholas Quirico, Branchburg, NJ (US)

(21) Appl. No.: 15/090,132

(22) Filed: Apr. 4, 2016

Related U.S. Application Data
(60) Provisional application No. 62/189,015, filed on Jul. 6, 2015.
(60) Provisional application No. 62/142,089, filed on Apr. 2, 2015.

(51) Int. Cl. G06Q 50/16; G06Q 30/06

(52) U.S. Cl. CPC G06Q 50/16; G06Q 30/0627

(57) ABSTRACT

A real estate listing search system includes: a processor; a database of real estate listing records in communication with the processor, each real estate listing record including a property, identified by a property identifier, and a plurality of real estate features associated with the property; a display in communication with the processor; and memory in communication with the processor, the memory including computer-readable instructions that, when executed by the processor cause the processor to: receive, from a user, a set of preferred real estate features; compile a list of real estate listing records ordered by a percentage of matching features, and display the list of real estate listing records on the display, the displayed list including the property identifier and a visual representation of the percentage of matching features.

### CROSS-REFERENCE TO RELATED APPLICATIONS

This application incorporates by reference and claims the benefit of priority to U.S. Provisional Patent Application No. 62/142,089, filed Apr. 2, 2015, and U.S. Provisional Patent Application No. 62/189,015, filed Jul. 6, 2015.

### BACKGROUND OF THE INVENTION

The present subject matter relates generally to a system and method for creating real estate listings by inputting information about the subject of the listing into a mobile application. More specifically, the present invention relates to software application for mobile devices that allows the user to access pre-populated templates relating to commonly featured real estate listing details, generate a corresponding listing page, communicate it to others, and search these listings.

Whenever a new real estate listing comes on the market, real estate agents are responsible for the arduous task of compiling information about the property's rooms, amenities, features, dimensions, and history. These details are essential to accurately represent the listing price of the home. In order to accomplish this task, listing agents typically keep hand-written notes about the relevant details. But this may only lead to further complications as the agent struggles to decipher hand-written notes. Further, loose paper may easily become lost or damaged.

After the agent has the necessary information, in order to create a printed listing of the property, the agent must take the notes and type them into software for generating listing sheets as well as upload and insert any pictures taken. This adds time to the listing process.

Additionally, when consumers look to purchase a home, they may already have an idea of what features and amenities they want in their home. Current real estate listings allow prospective buyers to search current listings and filter the results based off amenities (e.g., walk-in closet, dishwasher, etc.), but there is no efficient way for a consumer to input all the features they may want in their home and then search for matching listings.

Accordingly, there is a need for a system and method for efficiently inputting real estate information into a software application, generate a listing that may be communicated to others, and search these listings as described herein.

### BRIEF SUMMARY OF THE INVENTION

To meet the needs described above and others, the present disclosure provides a system and method for efficiently inputting real estate information into a software application, generating real estate listings that may be communicated to others, and searching these listings.

By providing a software application with pre-populated fields for designating commonly-listed features in a property, the application allows users to quickly and easily note the information they need about a property, access the information at a later time, view the information easily in an electronic interface, and use the information to generate a listing sheet. The application may include access to the existing functionalities of the mobile device, such as the camera, microphone, keypad and printing. The application may also access the Internet through wireless or wired communication links in order to enable functionalities such as email. The system may also include a website for creating, browsing, and updating real estate listings.

Users of the application may maintain user accounts with a history of listings. These accounts may be cloud based, allowing setting and information stored by one account to be shared by all other devices accessing the same account. Real estate agent users may additionally maintain a user profile that may be visible to other users of the application. This profile may include information about the geographic area the agent serves, success rate information, the agent's photo and the agent's contact information. Messaging between accounts may also be supported, ideally with prospective buyer accounts able to initiate conversations with real estate agent accounts.

In using the system, a user may enter the application and choose to access a previous listing or create a new listing. If the user selects the option of accessing a previous listing, the user may be directed to a page with a list of properties. This list may be organized by the address of each property, however the user may have the option of designating each property with a unique name.

If the user decides to create a new listing, the application may first prompt the user to enter information about the property that is the subject of the new listing. This information may include the property's address, the owner's name, the year the property was built, neighborhood features such as schools, the style of the home, the size of the home, taxes, and fields for the number of various rooms (e.g., 3 bedrooms, 2 bathrooms, 1 den, 1 living room, 1 kitchen, 1 library, 1 laundry room, etc.).

After the user provides the information about the property, the application generates a list of rooms. This list is based on the inputted room information. Each room is presented as an option on the room list, and by activating the each room option the user may be directed to another page with a list of fields for relevant information. For example, by selecting the “kitchen” option, the user may access a page that prompts the user for information about the style of the kitchen and when the kitchen was updated. Further, there may be categories to input the type of flooring, the lighting, the windows, etc. The information fields may appear as broad categories such as “kitchen flooring.” By activating this field with a touchscreen gesture such as a swipe or push, the user may be directed to another page with common options for kitchen flooring, such as tile, laminate, hardwood, etc. Depending on this selection, the application may direct the user to an additional page with more specific options. For example, if the user selects hardwood flooring, the application may navigate to another page listing types of hardwood flooring.

After the user selects the appropriate flooring type, the user may navigate back to the previous page with the list of kitchen information fields. This page may also include a blank field where the user may input additional features of the kitchen that are not reflected in the pre-populated list. Once the user is finished filling in all the information fields about the kitchen, the user may navigate back to the page with the lists of rooms. The user may then continue to access the room selections in the property and repeat the process of filling in information for each room.

At any point during the input process the user may have the option to edit the information he or she previously entered. For instance, the user may change the name of a room or the square footage. The user may rearrange the order of the listed rooms in order to dictate the order of the final brochure. Additionally, the user may have the option to add rooms or delete rooms. After the user has created the listing, the user may access the listing in the listing history and view the listing information or make additional edits.

When the user has inputted all the necessary information about the property, the user may have the option to create a finished brochure using the information the user populated. The user may then have the option to print the brochure, upload it to the Internet or social networking sites, or communicate it to others such as through an email or short messaging services (SMS). The user may also post the content of the brochure online in the form of a live listing. This listing may contain all details about a home and be browsed by prospective buyers using the system's mobile application or website. The data stored in the system (present on the brochures and/or listings) may also be mapped to other real estate software programs, portal sites, and/or online marketers. The present system may also pull information already present in other real estate programs to auto-populate some information about a property.

Additional features of the application may include the ability to store photos of and data about the property along with the listing information. This data may include insurance records and warranties. The user may also record recent repairs as well as the company or vendor who provided the repair along with their contact information. If a repair is outstanding, the system may display a suggested vendor for the repair and insert links or contact information for these vendors in finalized brochures. The completed brochure may be emailed to the homeowner with a field for the homeowner to provide an electronic signature to sign off on the content of the brochure.

The application may further include a panic button feature. This feature may appear on any page or a specifically designated page within the application. By activating the button, the user's device may initiate a phone call with a pre-designated emergency contact. The feature may be programmed to contact the emergency contact in one of more of a variety of communications, including SMS or email.

The system may also include on-screen tips which may be accessed through a prompt (for example, one that appears as a question mark), which when tapped, will provide the user with helpful hints.

Another potential feature of the application may allow a prospective home buying user to search home listings by identifying their desired qualities in a home utilizing the same or a similar interface as the one used by the real estate agent(s) who created the listings. The application may then return results that closely match the characteristics inputted by the user. The application may further rank the results based on the percentage of desired qualities each listing possesses.

In alternate embodiments of the system, the relevant property characteristics may vary to reflect the nature of the property. For example, the pre-populated options may vary to reflect commercial properties or unique or high-end homes.

In one example, a real estate listing search system includes: a processor; a database of real estate listing records in communication with the processor, each real estate listing record including a property, identified by a property identifier (e.g., an address), and a plurality of real estate features associated with the property; a display in communication with the processor; and memory in communication with the processor, the memory including computer-readable instructions that, when executed by the processor cause the processor to: receive, from a user, a set of preferred real estate features; compile a list of real estate listing records ordered by a percentage of matching features between the set of preferred real estate features and the features associated with each real estate listing record, and display the list of real estate listing records on the display, the displayed list including the property identifier and a visual representation of the percentage of matching features between the set of preferred real estate features and the features associated with each real estate listing record.

The percentage of matching features between the set of preferred real estate features and the features associated with each real estate listing record may be a weighted percentage of matching features. For example, a user may designate that matching for a garage is more important than matching for a pool even if both features are selected as being desired. In some examples, the weighted percentage of matching features is based, at least in part, on weights input from a user. In other examples, the weighted percentage of matching features is based, at least in part, on weights derived from analysis of a plurality of sets of preferred real estate features received from users. As such, the system can learn from data

The display may be a display on a user's mobile device. As such, a system server may cause the list to be displayed via a mobile application on a user's device. Alternatively, the list may be displayed via a website.

The visual representation of the percentage of matching features between the set of preferred real estate features and the features associated with each real estate listing record may be a number (e.g., 98%), may be color-coded (e.g., red is a high degree of matching, blue is a low degree of matching), may be a graphic image visually identifying a percentage (e.g., a pie chart or a “temperature” gauge), etc.

An object of the invention is to provide a solution to compiling real estate listing information that is easy to use, convenient, accurate and reliable. Current systems and methods for creating complete and well-formatted listings involve use of multiple cumbersome applications and hardware devices (e.g., laptop, camera, smartphone, etc.). The present invention allows for one application running on a smartphone or other mobile computing device to take the place of a full suite of software applications and multiple pieces of expensive hardware.

Another object of the invention is to improve the efficiency of listing properties by automatically generating listing brochures and reducing the time it takes to type hand-written notes. While no two homes are exactly the same, most have similar features which can be accounted for ahead of time in convenient to use, prepopulated lists. Additionally, the more the system is used and more feedback from users is obtained, the lists of features can be made larger (or smaller) to make for even more efficient listings.

One advantage of the invention is that it eliminates the need for hand-written notes. Walking around a property for sale or rent in order to assess all the dwelling's features is time consuming and taking handwritten notes while doing so slows this process down further. Additionally, paper notes can be easily lost, smudged, or other otherwise unreadable at a later time, potentially creating even more work for real estate agents. The present invention allows users to walk around property with their mobile computing device and input notes with a simple touchscreen gesture. This saves time, paper, ink, and creates a set of notes which can then be uploaded to the internet or emailed to ensure they are never lost.

Another advantage of the invention is that the user interface may vary according to the nature of the property. Given that there are a multitude of home types (e.g., apartments, condos, single family homes, trailers, etc.) the present invention is able to tailor the potential feature lists to help speed up note taking. Once such example would be that of an apartment on the second floor or above in an apartment building. Since the apartment is not on the ground floor, options to select features such as a patio or yard are likely not relevant, but options for an elevator and other handicap access likely are. The present invention may not display options to input information for a yard, etc. when irrelevant, but this information can still be input manually if the property has unusual features.

A further advantage of the invention is that it maintains a history of property listings that the user may access at a later date. This feature is advantageous both for busy real estate agents who can keep track of all the properties for which they are acting as a broker and for potential buyers who can keep track of homes they have and have not viewed.

Yet another advantage of the invention is that it allows real estate agents to input information prior to securing a listing and then supplement that information with additional details once the listing is secured. This saves the real estate agent time in the long run and demonstrates the agent's efficiency to the homeowner.

Still yet another advantage of the invention is that it provides potential home buyers a powerful search tool for determining properties which closely match their wants and needs. Many home buyers are extremely meticulous when selecting a home and the present invention provides a means to not only search by features on an individual room level, but also provides a listing of the percentage of matching features prospective homes have in comparison to a buyer's wish list. This invention also provides potential home buyers with an easy-to-use tool for determining accurate listing prices of properties with features they prefer.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a login screen at the front end of a real estate listing application.

FIG. 2 illustrates a screen of the real estate listing application through which a real estate agent may access the components of the agent's profile.

FIG. 3 illustrates a screen of the real estate listing application through which a real estate agent user may access previous listings that the agent created using the application.

FIGS. 4a-4d illustrate a series of screens of the real estate listing application through which a user generates a new listing.

FIG. 5 illustrates a screen of the real estate listing application through which a user provides information about rooms in a home.

FIG. 6 illustrates a screen of the real estate listing application through which a user provides information about room features.

FIG. 7 illustrates a screen of the real estate listing application through which a user designates characteristics of room features.

FIG. 8 illustrates a screen of the real estate listing application through which additional details about a room feature may be designated.

FIGS. 9a-9c illustrate screens of the real estate listing application through which a brochure and/or listing may be finalized as part of a listing generation process.

FIG. 10 illustrates a screen of the real estate listing application through which a user emails a completed real estate brochure.

FIG. 11 is a brochure generated using the of the real estate listing application.

FIG. 12 illustrates a screen of the real estate listing application through which a user publishes a live real estate listing.

FIG. 13 illustrates a screen of the real estate listing application through which a user searches system listings.

FIG. 14 illustrates a screen of the real estate listing application through which a user inputs home features to be used as search parameters.

FIG. 15 illustrates a screen of the real estate listing application through which search results generated by the system's percentage matching algorithm are displayed.

FIG. 16 is a schematic diagram illustrating an example of a user device for operating the real estate listing application.

### DETAILED DESCRIPTION OF THE DRAWINGS

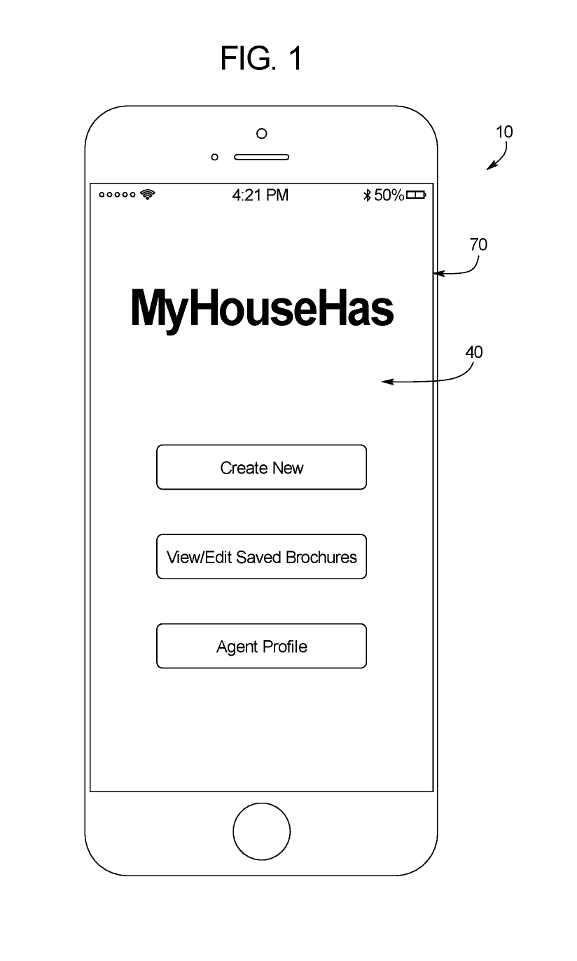

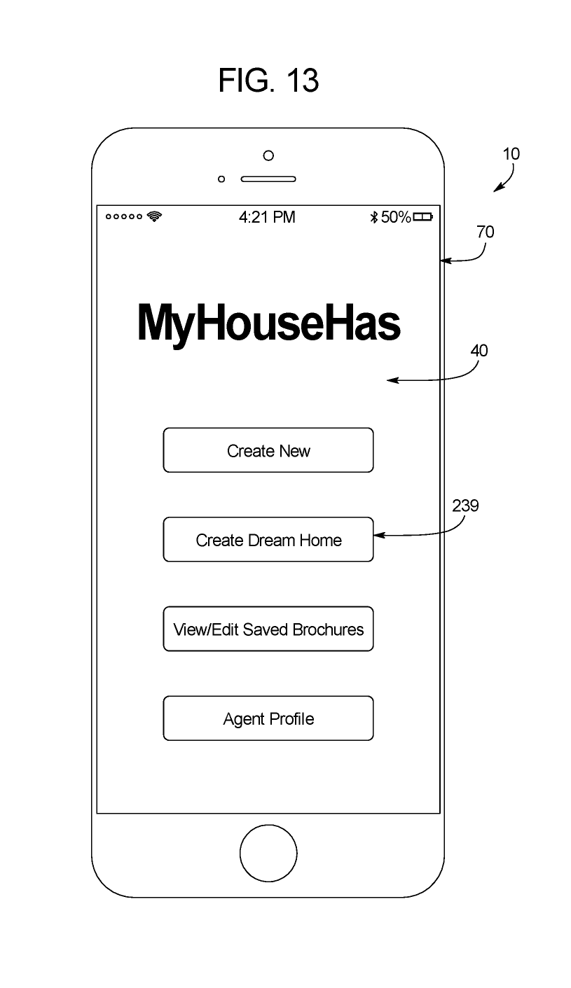

FIG. 1 illustrates an example of a login screen that may be used at the front end of a real estate listing application 70 embodying a real estate listing system 10. The examples shown in FIGS. 1-12 illustrate aspects of a user interface 40 from the perspective of a real estate agent user. An analogous user interface 40 may be provided for a prospective homeowner (through a mobile or web application), where the functionality is limited to the scope appropriate for access by the customer. For example, the homeowner may not have access to a history of listed properties, nor would the homeowner have an agent profile within the application. FIGS. 13-16 show aspects of the user interface 40 from the perspective of a prospective home buyer.

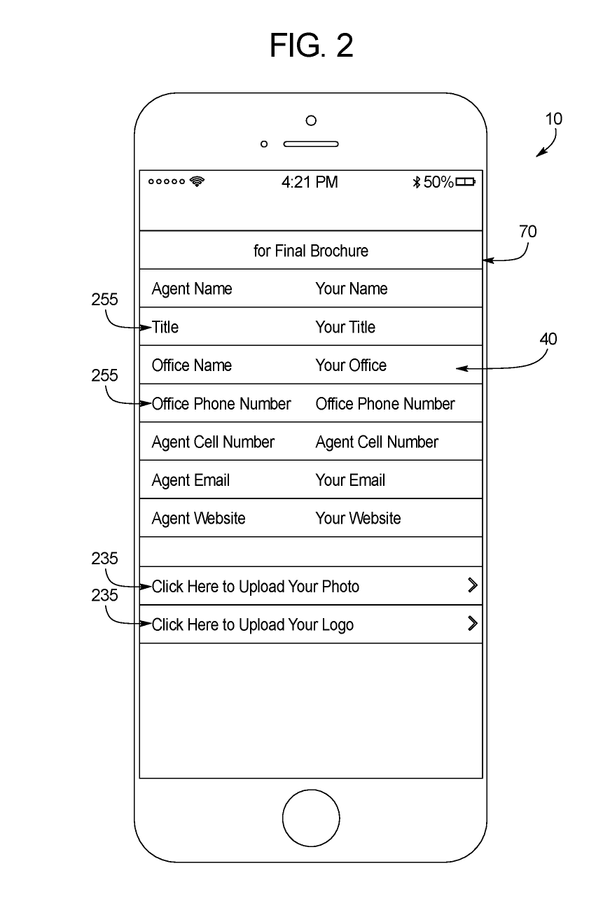

FIG. 2 illustrates a screen of the user interface 40 of the user device application 70 through which a real estate agent may access the components of the agent's profile. Using touchscreen buttons 235, dropdown menus 245, and free response fields 255, a real estate agent user may provide textual information 201 about the agent's business and upload corresponding images and/or video 202. The information 201 and images 202 the agent enters into the interface 40 may appear on final listing brochures 300 and online listings 400 created using the system 10.

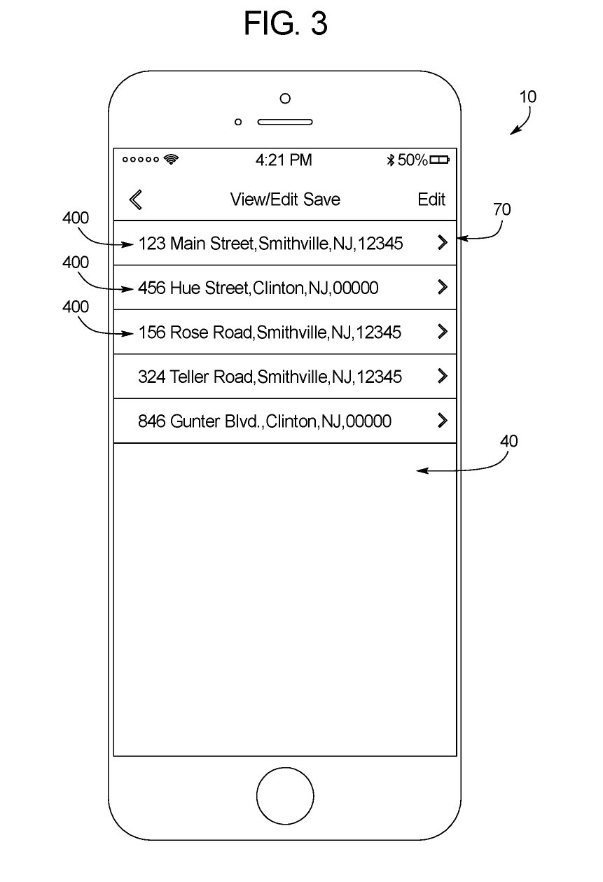

FIG. 3 illustrates a screen of the user interface 40 of the user device application 70 through which a real estate agent user may access previous listings 400 that the agent created using the application 70. The listings 400 shown may be selected by tapping the user device's 30 touchscreen 134. Selecting a listing 400 directs the user to the text information 201 and images 202 stored by the system 10 for the given listing 400. The text information 201 and images 202 stored by the system 10 may be edited at any time.

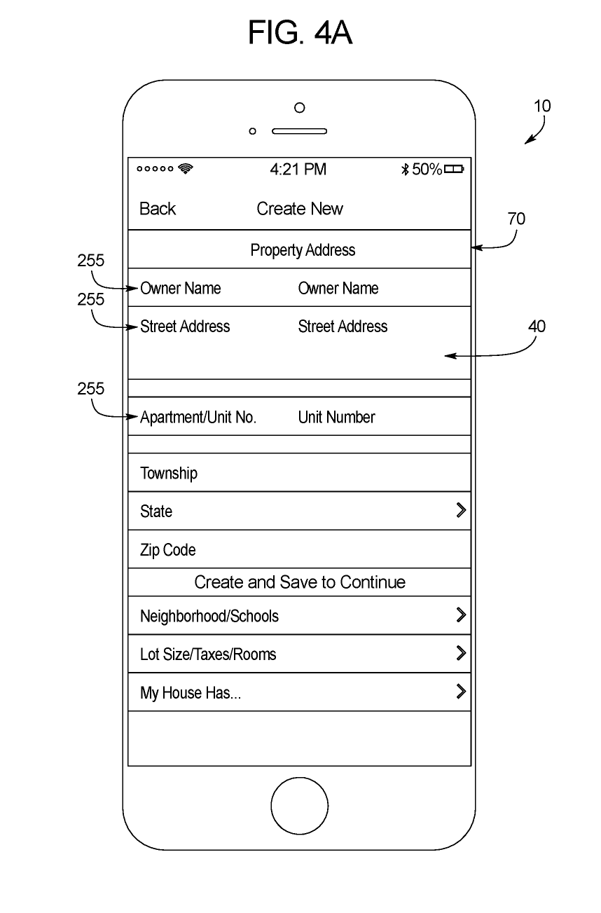

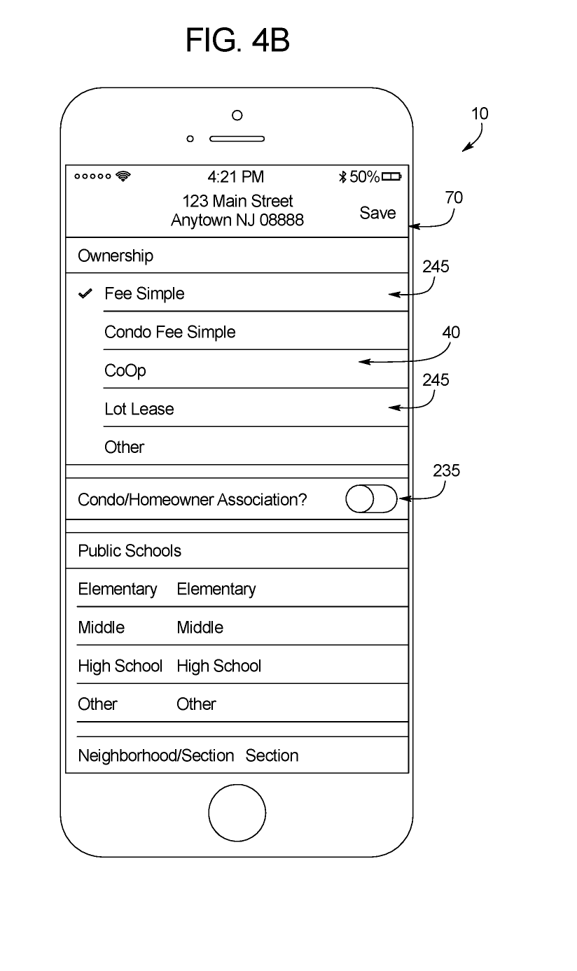

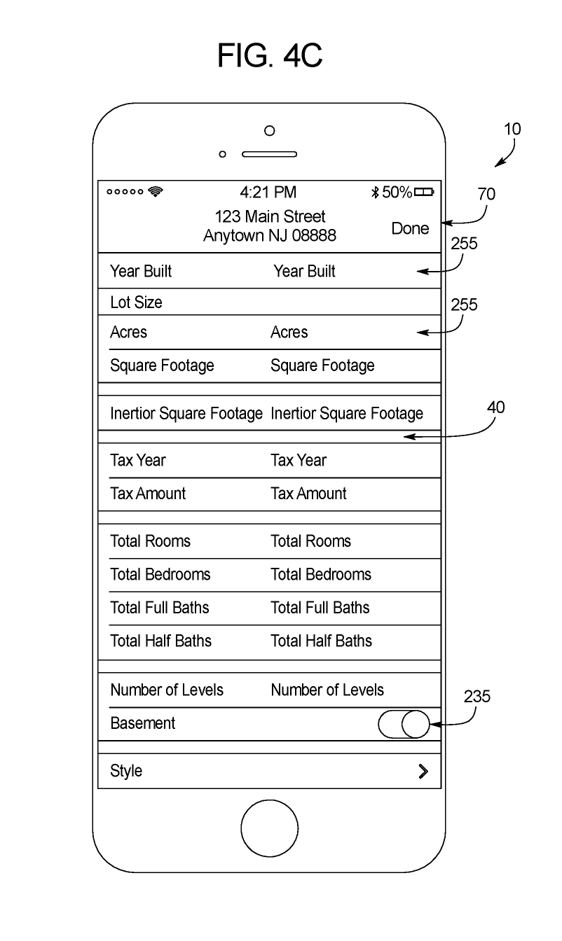

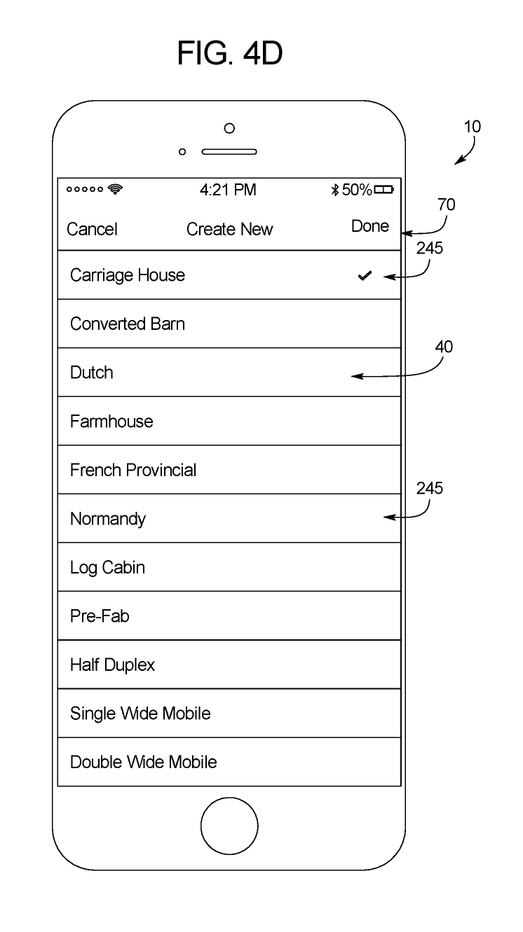

FIGS. 4A-4D show a series of screens used in the process of generating a new listing 400 via the user device application 70. As shown, the first step in creating a new listing 400 involves inputting information such as the property owner's name, geographic location of the property being listed, ownership type, tax information, nearby schools, lot size and square footage, room information, and property style. All of this information may be entered via touchscreen buttons 235, pre-populated dropdown lists 245, and/or free response fields 255 that are part of the user interface 40. It is understood that the amount of text information 201 input may vary across embodiments of the invention and that not all text information 201 must be populated by the user. It is also understood additional or alternative information may be required or optionally input. Real estate agents notes may also be recorded within these screens in separate free response fields 255 and optionally included within the final brochure 300 and/or listing 400.

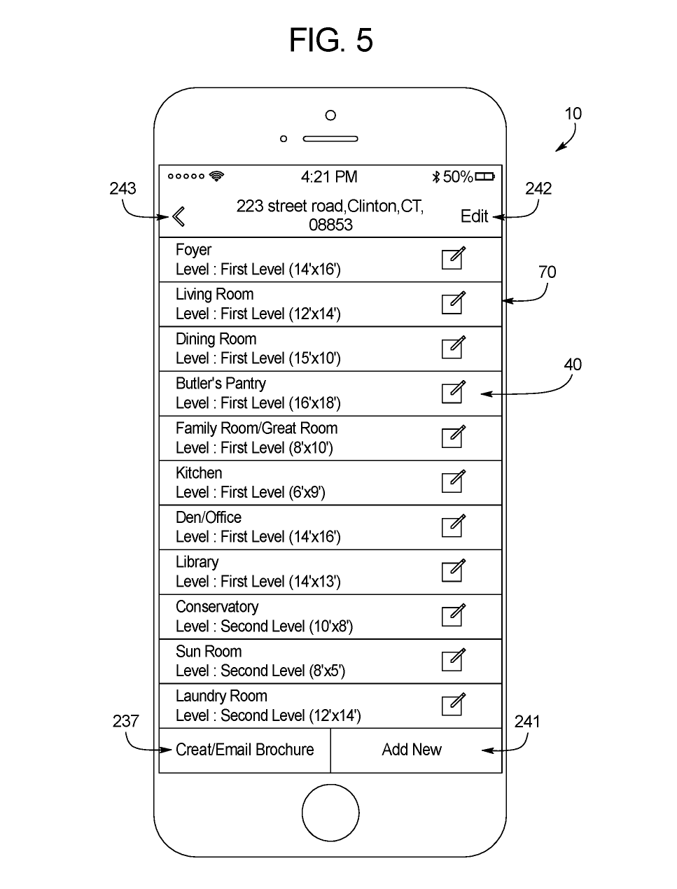

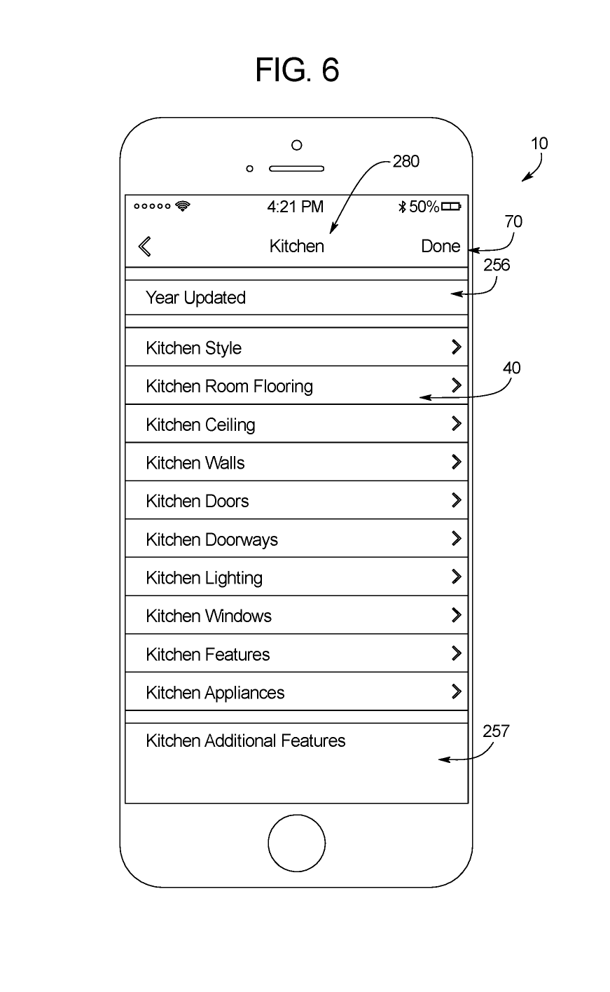

FIG. 5 illustrates a screen of the user interface 40 of the user device application 70 through which text information 201 about various rooms in a home may be entered and reviewed as a second step in the listing generation process. As shown in FIG. 5, the text information 201 input into the system 10 using the functionality discussed in FIGS. 4A-4D concerning the types of rooms in a home may be reviewed by the user once input. By selecting a room from the list shown in FIG. 5, the user may access a submenu 280 that is populated with the text information 201 that corresponds to the room selected. FIG. 6 shows an exemplary submenu 280 for a kitchen.

FIG. 5 also includes an option to navigate to the previous step in the listing generation process. In this example, the navigation selection is shown as a touchscreen button 235 in the form of an arrow button 243, but this button 243 may be shown in a variety of ways, including the wording “back.”

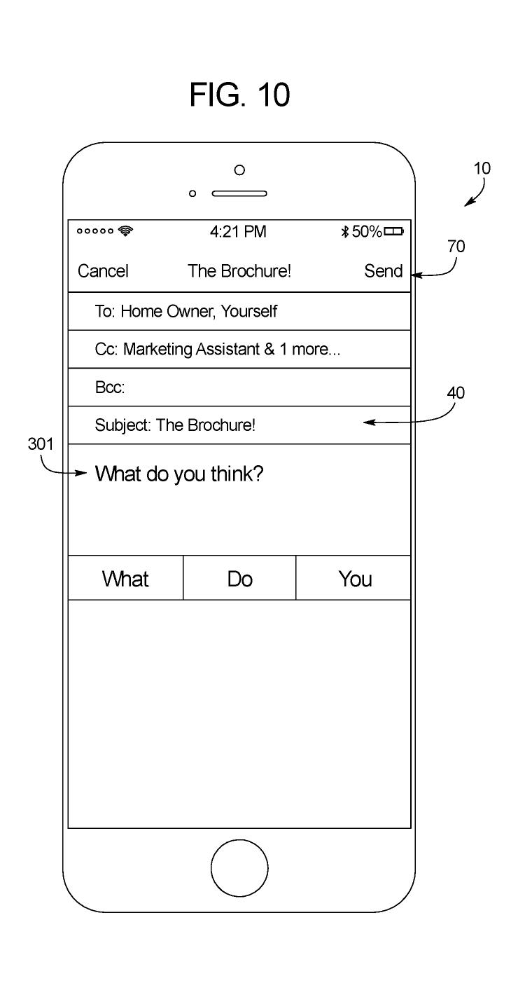

FIG. 5 further includes a touchscreen button 235 for creating and emailing a finished brochure 300. By tapping the “Create/Email Brochure” button 237, the user may be directed to another screen where they may create an email 301 with the finished brochure 300 as an attachment. An example of this email screen is shown in FIG. 10.

FIG. 5 also includes a touchscreen button 235 for adding a new room to the list of rooms. If the user taps the “Add New” button 241, a screen may appear prompting the user to enter text information 201 about the new room. This text information 201 may include the room name, the room size and the level of the property that the room is on, but it is understood that the necessary information is not limited to those characteristics.

FIG. 5 further includes an edit button 242 to edit the listing of rooms. By selecting this option, the order of the list of rooms may be altered. This edit button 242 may also allow the user to select one of the rooms and access a menu of edit options or delete the room from the list.

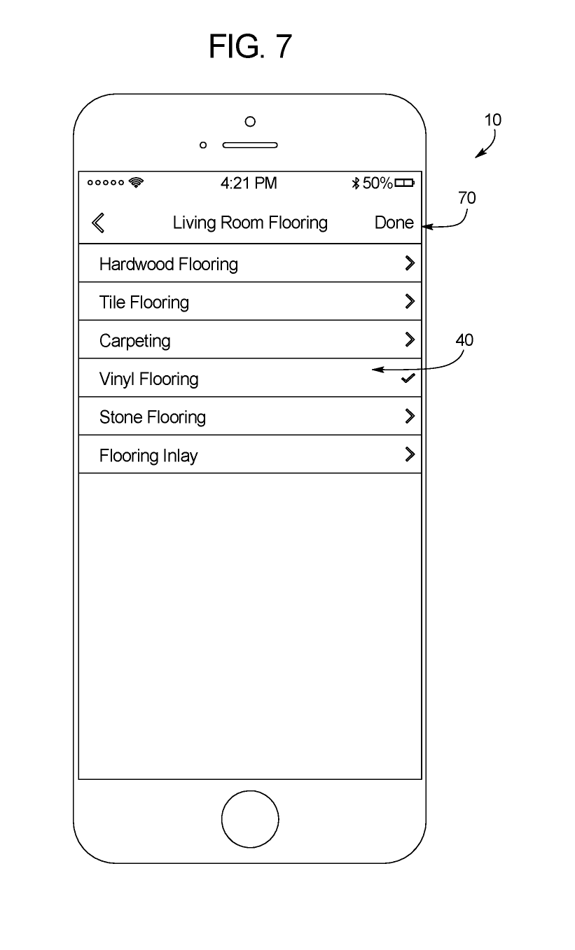

FIG. 6 illustrates a screen of the user interface 40 of the user device application 70 through which a user may input room features as a third step in the listing generation process. As shown in FIG. 6, the user may access a catalog of features that the user may select in order to designate details of a selected feature of a room in a home. For example, by selecting the “Kitchen Room Flooring” the user is taken to a screen similar to the one shown in FIG. 7, where the user may select the details corresponding to the selected feature in FIG. 6. The list of features shown in FIG. 6 is not exhaustive, and it is understood that additional or alternative features may be listed.

FIG. 6 additionally includes a free response field 255 for inputting information about when the room selected from FIG. 5 was last updated 256. Also, FIG. 6 illustrates another free response field 255 that the user may utilize in order to input additional features 257 of the selected room. By accessing either of the free response fields 255, the application 70 may initiate a keyboard function, allowing the user to enter the desired information.

FIG. 7 illustrates a screen of the user interface 40 of the user device application 70 through which a user may designate characteristics of a room feature. The example shown in FIG. 7 presents a list of flooring options including hardwood flooring, tile, and carpeting. At the top of the screen shown in FIG. 7, the user device application 70 indicates that the details relate to the flooring of a living room. The list of flooring details is exemplary. It is understood that additional or alternative flooring types may be included.

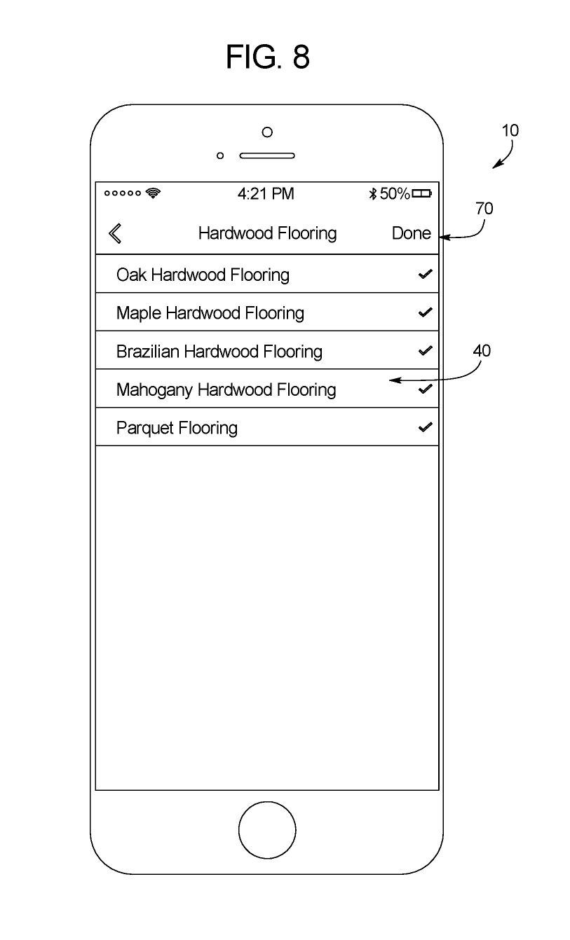

Upon selecting a feature in FIG. 7, the user may be directed to the screen shown in FIG. 8. As shown in FIG. 8, the user may input additional details about the room feature selected in FIG. 7 by indicating a more precise description detail from the screen presented in FIG. 8. For example, if the user selected hardwood flooring from the selections in FIG. 7, the user would be directed to the screen in FIG. 8 prompting the user to indicate the specific type of hardwood flooring.

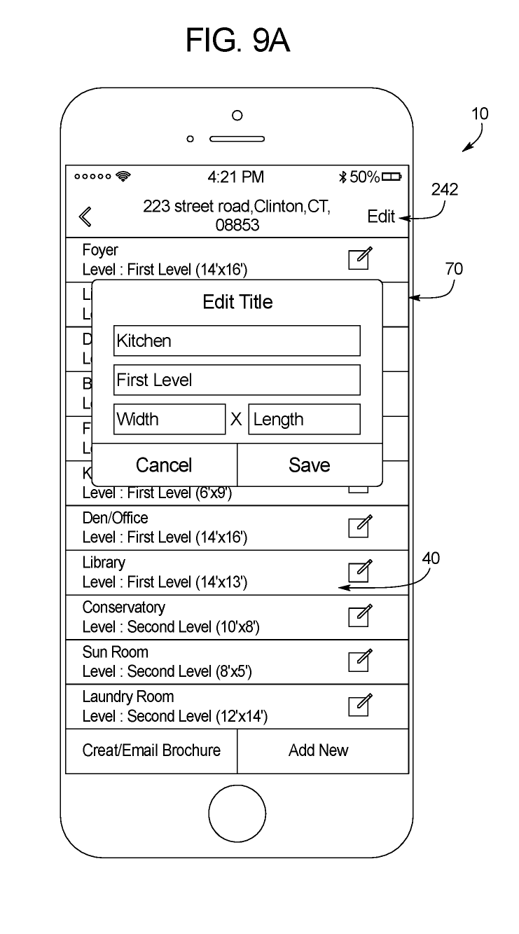

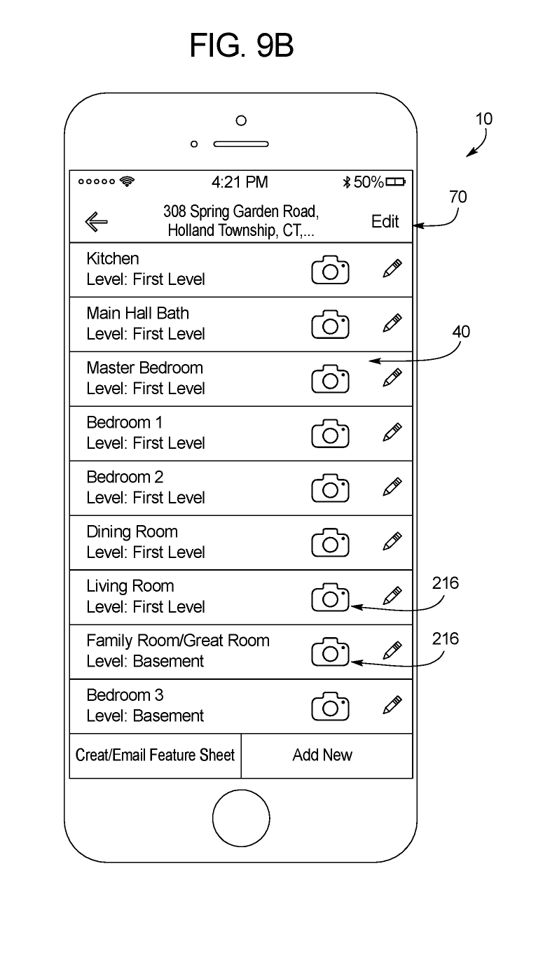

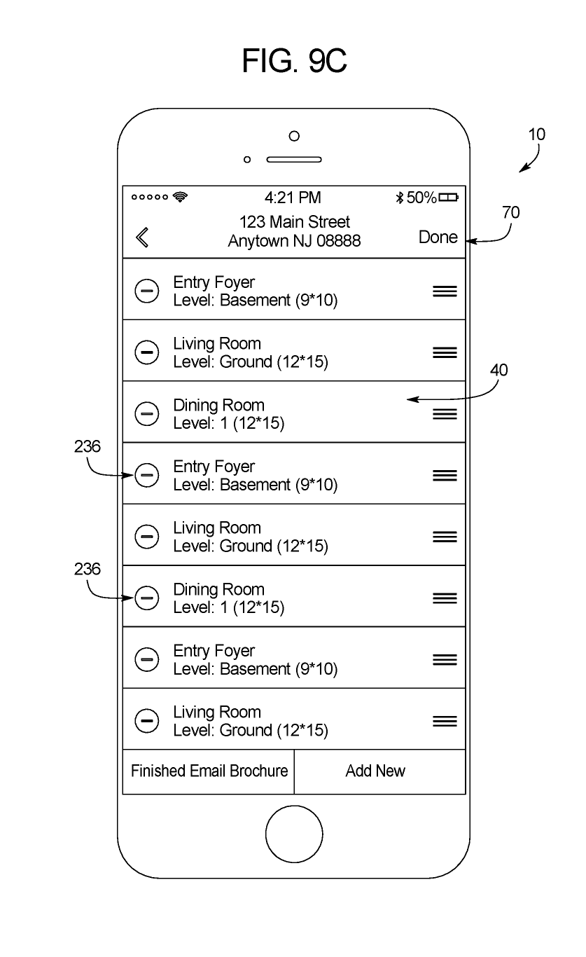

FIGS. 9A-9C illustrate screens of the user interface 40 of the user device application 70 through which a completed brochure 300 and/or listing 400 may be finalized as part of a final step on the listing generation process. Once all the desired text information 201 about a home, its rooms, and various features has been input, a user may create a finalized PDF brochure 300 via the user interface 40 shown in FIGS. 9A-9C. If, however there is an issue with one of rooms listed on the brochure 300, a user may edit basic information about the room directly from the brochure 300 creation screen. FIG. 9A shows this functionality: if a user wants to edit information about a room, the kitchen in this example, the user taps the edit button 242 and selects the kitchen from the list. From here, the user can edit basic information about the kitchen and save these updates. The user may also choose which rooms' information to add to a PDF, or alternatively, to add the information for all rooms at once.

Additionally, from the brochure 300 creation screen, users may also add images 202 which are associated with the text information 201 for each room in a listing 400. As shown in FIG. 9B, if a user wishes to add images 202 for a given room, they may press the camera button 216. If a user taps the camera button 216, the user device application 70 may activate the user device's camera subsystem 116 and display to the user a camera interface with which the user can capture images 202 that are stored by the application 70. More than one image 202 may be stored by the system 10 for each room.

Finally, FIG. 9C is an exemplary iteration of the deletion function present on the brochure creation screen. If a user wishes to remove a room from a brochure 300 and/or listing 400, they may perform this action from the screen shown in FIGS. 9A-9C. To do so, the user may press the edit button 235 discussed in FIG. 9A, but instead of updating the information, the user may use the deletion button 236 that appears next to each room listed to remove the room(s) from the brochure 300 and/or listing 400.

FIG. 10 is a system screen demonstrating the user interface 40 of the user device application 70 being utilized to email a completed real estate brochure 300. As shown in FIG. 10, once a user is ready to distribute a real estate brochure 300, the user may utilize the “Create/Email Brochure” button 237 shown in FIG. 5 and FIGS. 9A-9C. When selected, the “Create/Email Brochure” button 237 will create a brochure with the text information 201 and images 202 stored by the system 10 for the given home. The system 10 then opens an email message 301 within an email client and attaches the brochure 300 along with a stock message. The list of rooms included in the brochure email 301 may be collapsible to allow for easier browsing. Once the email 301 is created the user can then input prospective customer(s) email addresses along with any other details needed and send out the brochure 300.

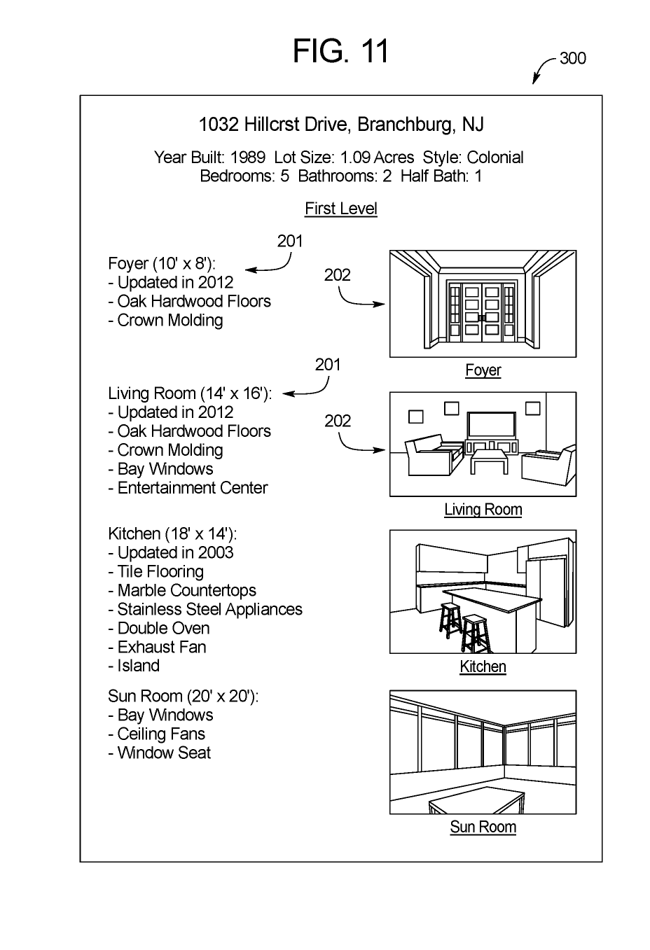

FIG. 11 illustrates a completed brochure 300 generated using the listing creation screens shown in FIGS. 4-9. As shown in FIG. 11, the complete brochure 300 may feature both the text information 201 entered into the system 10 and corresponding images 202 captured with the user device's 30 camera subsystem 116. The completed brochure 300 is formatted in a way that aligns the respective images 202 with the corresponding text information 201 for a given room and the brochure is generated into Portable Document Format (PDF) or other suitable file format.

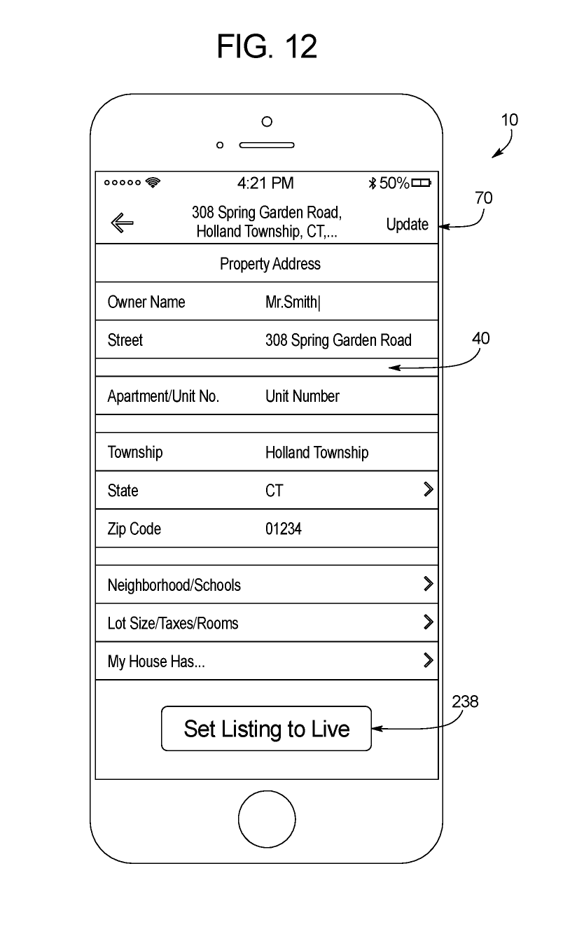

FIG. 12 illustrates the listing 400 posting functionality of the real estate listing system 10. As shown in FIG. 12, if a user wishes to post the text information 201 and images 202 they have recorded about a home utilizing the user device application 70 they may select a “Set Listing to Live” button 238. When the “Set Listing to Live” button 238 is selected, the system 10 will transmit the text information 201 and images 202 recorded by the application 70 to a website which posts the listing 400 for all to see. The information sent to this website will be similar in content to that present in the completed brochure 300 mentioned in FIG. 11. The website may be accessed from anywhere via internet connection and may be updated via the user device application 70 or web browser. Real estate agents may log into this website via secure access to update listings and contact clients. The user device application 70 may also queue listings to be posted live when the user device 30 is offline. Once the device 30 has internet access, the application 70 may then post the listings to the system 10 website.

The listing process described in FIGS. 1-12 is a highly efficient, self-guided process that is valuable to real estate agents and homeowners alike. As shown, the property feature catalogue is detailed, interrelated, and updated with respect to the size and style of the property. The application provides an efficient platform for the real estate agents to provide information that may be used to generate a listing brochure. It also provides a customer facing application that allows customers to designate the features of their home for the purpose of arriving at an accurate listing price.

FIG. 13 is a system screen of the user device application 70 being utilized to searching system listings 400. As shown in FIG. 13, if a user wishes to search real estate listings 400 posted within the system 10, the user may begin by selecting the touchscreen “Create Dream Home” button 239. When the “Create Dream Home” button 239 is pressed, the user is presented with a series of screens similar to those utilized by real estate agents to create system listings 400, as described with respect to FIG. 1-12.

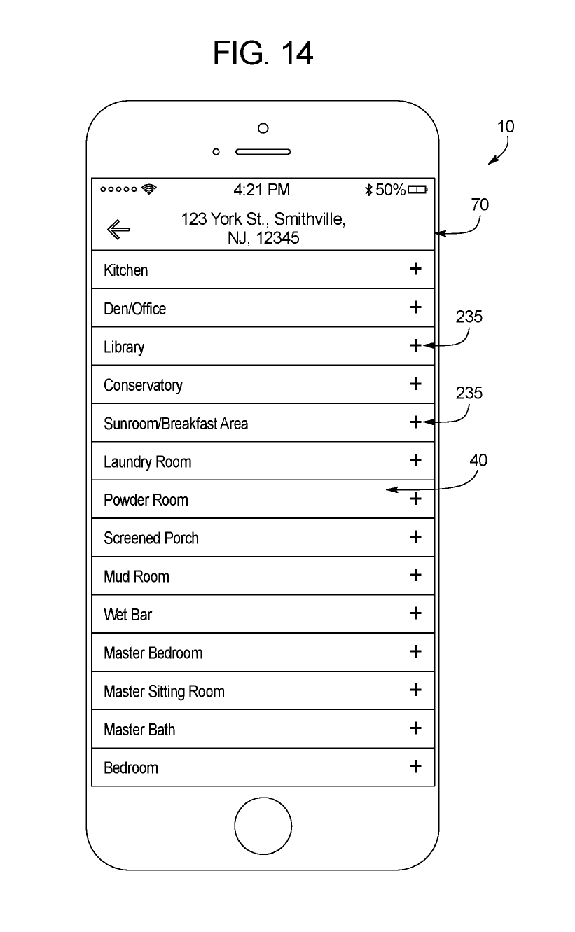

FIG. 14 is a system screen of the user device application 70 through which a user may input preferred home features with which the system 10 is to be searched. As shown in FIG. 14, a potential buyer may input the buyer's preferred home features into the user device application 70 using a series of touchscreen buttons 235, dropdown lists 245, and free response fields 255. Once the potential buyer has input all the preferred home features for which the potential buyer wishes to search in the system listings 400, the potential buyer may then initiate a search of the listings 400 by directing the system 10 to do so via another touchscreen button 235 or other input.

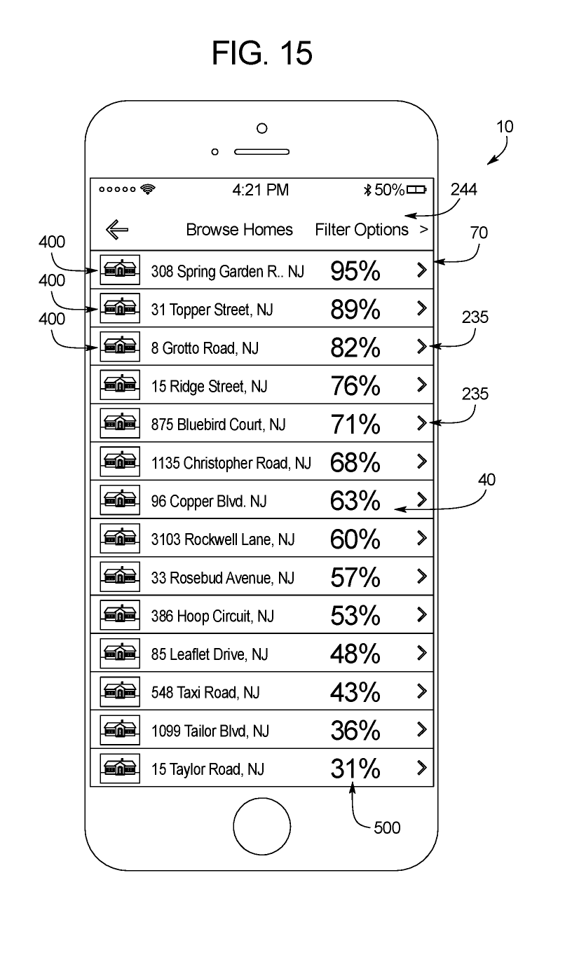

FIG. 15 is a system screen displaying search results generated by the system's 10 percentage matching algorithm 500. As shown in FIG. 15, when a user inputs preferred home features and initiates a system 10 search of current listings 400, the system 10 utilizes a percentage matching algorithm 500 which analyzes the user's preferred features against the features listed for available home listings 400 stored in the system 10. Once this comparison is complete, the system 10 will then display a list of home previews 430 in descending order based off the percentage of preferred features present in each respective home.

The algorithm 500 may also assign pre-determined, weighted scores to certain features which are of more importance to home buyers. For instance, if two properties each have 75% of features matching, but one property has a second bathroom (a feature preferred by most users) while the other property has a dance floor (another feature preferred by the user, but likely superfluous to most users) the system may rank the property with the non-superfluous feature(s) higher in the list than the property with features unlikely to be sale determinative. The results produced by the percentage matching algorithm 500 may be further refined by other filtering options, accessed via a touchscreen button 244. Each listing 400 may also be accessed from the results screen by tapping the home preview(s) 430 which act as touchscreen buttons 235 which link to their corresponding listing(s) 400.

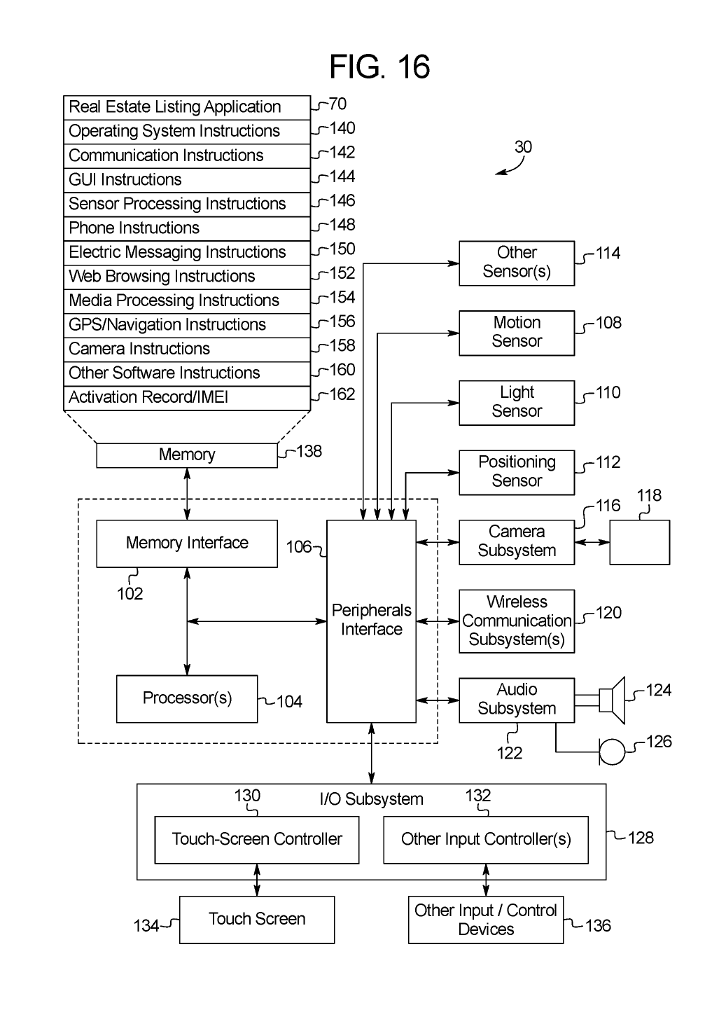

FIG. 16 is a schematic diagram illustrating an example of a standalone real estate listing application 70 running on a user device 30. As shown in FIG. 16, the user device 30 maybe a mobile device, such as a smartphone, running a standalone real estate listing application 70 to provide the functionality described herein. A user may install the real estate listing application 70 on his or her user device 30 and launch it via touchscreen icon 21. The user device 30 may include wireless communication subsystem 120 to communicate with one or more media sharing mediums.

The user device 30 may include a memory interface 102, controllers 103, such as one or more data processors, image processors and/or central processors, and a peripherals interface 106. The memory interface 102, the one or more controllers 103 and/or the peripherals interface 106 can be separate components or can be integrated in one or more integrated circuits. The various components in the user device 30 can be coupled by one or more communication buses or signal lines, as will be recognized by those skilled in the art.

Sensors, devices, and additional subsystems can be coupled to the peripherals interface 106 to facilitate various functionalities. For example, a motion sensor 108 (e.g., a gyroscope), a light sensor 163, and positioning sensors 112 (e.g., GPS receiver, accelerometer) can be coupled to the peripherals interface 106 to facilitate the orientation, lighting, and positioning functions described further herein. Other sensors 114 can also be connected to the peripherals interface 106, such as a proximity sensor, a temperature sensor, a biometric sensor, or other sensing device, to facilitate related functionalities.

A camera subsystem 116 and an optical sensor 118 (e.g., a charged coupled device (CCD) or a complementary metal-oxide semiconductor (CMOS) optical sensor) can be utilized to facilitate camera functions, such as recording photographs and video clips.

Communication functions can be facilitated through a network interface, such as one or more wireless communication subsystems 120, which can include radio frequency receivers and transmitters and/or optical (e.g., infrared) receivers and transmitters. The specific design and implementation of the communication subsystem 120 can depend on the communication network(s) over which the user device 30 is intended to operate. For example, the user device 30 can include communication subsystems 120 designed to operate over a GSM network, a GPRS network, an EDGE network, a Wi-Fi or Imax network, and a Bluetooth network. In particular, the wireless communication subsystems 120 may include hosting protocols such that the user device 30 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 may include a touch screen controller 130 and/or other input controller(s) 132. The touch-screen controller 130 can be coupled to a touch screen 134, such as a touch screen. The touch screen 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 may be coupled to memory 138. The memory 138 can include high-speed random access memory and/or non-volatile memory, such as one or more magnetic disk storage devices, one or more optical storage devices, and/or flash memory (e.g., NAND, NOR). The memory 138 may store operating system instructions 140, such as Darwin, RTXC, LINUX, UNIX, OS X, iOS, ANDROID, BLACKBERRY OS, BLACKBERRY 10, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 138 may also store communication instructions 142 to facilitate communicating with one or more additional devices, one or more computers and/or one or more servers. The memory 138 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 138 may also store other software instructions controlling other processes and functions of the user device 30 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 138.

Each of the above identified instructions and applications can correspond to a set of instructions for performing one or more functions described herein. These instructions need not be implemented as separate software programs, procedures, or modules. The memory 138 can include additional instructions or fewer instructions. Furthermore, various functions of the user device 30 may be implemented in hardware and/or in software, including in one or more signal processing and/or application specific integrated circuits. Accordingly, the user device 30, as shown in FIG. 16, may be adapted to perform any combination of the functionality described herein.

Aspects of the systems and methods described herein are controlled by one or more controllers 103. The one or more controllers 103 may be adapted run a variety of application programs, access and store data, including accessing and storing data in associated databases, and enable one or more interactions via the user device 30. Typically, the one or more controllers 103 are implemented by one or more programmable data processing devices. The hardware elements, operating systems, and programming languages of such devices are conventional in nature, and it is presumed that those skilled in the art are adequately familiar therewith.

For example, the one or more controllers 103 may be a PC based implementation of a central control processing system utilizing a central processing unit (CPU), memories and an interconnect bus. The CPU may contain a single microprocessor, or it may contain a plurality of microcontrollers 103 for configuring the CPU as a multi-processor system. The memories include a main memory, such as a dynamic random access memory (DRAM) and cache, as well as a read only memory, such as a PROM, EPROM, FLASH-EPROM, or the like. The system may also include any form of volatile or non-volatile memory. In operation, the main memory is non-transitory and stores at least portions of instructions for execution by the CPU and data for processing in accord with the executed instructions.

The one or more controllers 103 may further include appropriate input/output ports for interconnection with one or more output displays (e.g., monitors, printers, touchscreen 134, motion-sensing input device 108, etc.) and one or more input mechanisms (e.g., keyboard, mouse, voice, touch, bioelectric devices, magnetic reader, RFID reader, barcode reader, touchscreen 134, motion-sensing input device 108, etc.) serving as one or more user interfaces for the processor. For example, the one or more controllers 103 may include a graphics subsystem to drive the output display. The links of the peripherals to the system may be wired connections or use wireless communications.

Although summarized above as a PC-type implementation, those skilled in the art will recognize that the one or more controllers 103 also encompasses systems such as host computers, servers, workstations, network terminals, and the like. Further one or more controllers 103 may be embodied in a user device 30, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a processor or other programmable equipment to perform the relevant steps, where the code or instructions are carried by or otherwise embodied in a medium readable by the processor or other machine. Instructions or code for implementing such operations may be in the form of computer instruction in any form (e.g., source code, object code, interpreted code, etc.) stored in or carried by any tangible readable medium.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A real estate listing search system comprising:
a processor;
a database of real estate listing records in communication with the processor, each real estate listing record including a property, identified by a property identifier, and a plurality of real estate features associated with the property;
a display in communication with the processor; and
memory in communication with the processor, the memory including computer-readable instructions that, when executed by the processor cause the processor to:
receive, from a user, a set of preferred real estate features;
compile a list of real estate listing records ordered by a percentage of matching features between the set of preferred real estate features and the features associated with each real estate listing record, and
display the list of real estate listing records on the display, the displayed list including the property identifier and a visual representation of the percentage of matching features between the set of preferred real estate features and the features associated with each real estate listing record.

2. The system of claim 1, wherein the percentage of matching features between the set of preferred real estate features and the features associated with each real estate listing record is a weighted percentage of matching features.

3. The system of claim 2, wherein the weighted percentage of matching features is based, at least in part, on weights input from a user.

4. The system of claim 2, wherein the weighted percentage of matching features is based, at least in part, on weights derived from from analysis of a plurality of sets of preferred real estate features received from users.

5. The system of claim 1, wherein the display is a display on a user's mobile device.

6. The system of claim 1, wherein the display is a webpage.

7. The system of claim 1, wherein the property identifier is an address.

8. The system of claim 1, wherein the visual representation of the percentage of matching features between the set of preferred real estate features and the features associated with each real estate listing record is a number.

9. The system of claim 1, wherein the visual representation of the percentage of matching features between the set of preferred real estate features and the features associated with each real estate listing record is color-coded.

10. The system of claim 1, wherein the visual representation of the percentage of matching features between the set of preferred real estate features and the features associated with each real estate listing record is a graphic image visually identifying a percentage.
